(19) United States
(12) Patent Application Publication
(10) Pub. No.: US 2026/0358189 A1
(43) Pub. Date: Nov. 12, 2026

(54) FIBER OPTIC CABLE TEST DEVICE (SOURCE AND/OR METER) WITH SINGLE BUTTON/LIGHT-BASED FEEDBACK DRIVEN WORKFLOW

(71) Applicant: VIAVI SOLUTIONS INC., Chandler, AZ (US)

(72) Inventors: Christopher Daniel BOBEK, Fishers, IN (US); Julian Johannes WILMERS, Riederich (DE); Loren EGGERT, Poland, IN (US)

(73) Assignee: VIAVI SOLUTIONS INC., Chandler, AZ (US)

(21) Appl. No.: 19/202,347

(22) Filed: May 8, 2025

(51) Int. Cl. G01M 11/02; G01M 11/00

(52) U.S. Cl. CPC G01M 11/0207; G01M 11/0242; G01M 11/3181; G01M 11/337; G01M 11/3154

(57) ABSTRACT

A portable fiber optic cable test device (source and/or meter) may include a single button to initiate a testing/measurement workflow and a feedback light panel to indicate the present status of the testing/measurement workflow such that, barring a problem in the testing/measurement workflow, the user need only press the single button and watch the feedback light panel to perform the complete testing/measurement workflow for a fiber optic cable. In one aspect, the button and feedback light panel are combined into an integrated button/feedback light panel. Because workflow-stopping problems occur infrequently, the user of the present portable fiber optic cable test device may test, for example, more than a hundred fiber optic cables, or “Device(s) Under Test” (DUTs), in a work period by merely connecting each fiber optic cable/DUT and pressing a single button (in addition to, in some examples, other activities such as visual inspections of ferrule surfaces).

### TECHNICAL FIELD

The disclosure relates generally to test instruments for fiber optic cables, and more specifically, to test instruments that may perform measurements, quantify characteristics of, and/or otherwise analyze fiber optic cables, networks including fiber optic cable, and/or communications which are transmitted, at least in part, over fiber optic cables.

### BACKGROUND

Fiber optic cable may be employed in a large variety of communication networks, ranging from Ethernet networks to telecommunication networks and/or the Internet. Broadly speaking, a fiber optic cable may be a flexible cable that contains one or more flexible optical fibers which act as optical waveguides for light signals. When being used for such communication, fiber optic cable may need to meet certain standards for optimal operability based on deployment and usage, including, for example, levels of transmissibility as a light medium, levels of cleanliness of end connectors (particularly ferrule surfaces), and/or a lack of defects in manufacturing, structure, and/or materials. Moreover, the physical characteristics of fiber optic cable in specific deployments may need to be measured, tested, and verified, including, for example, the actual length of the cable, the types of connection and configurations being employed, the types of cabling being utilized, etc.

Accordingly, portable test instruments may be utilized by technicians to test, measure, and/or verify the level of operability and/or physical characteristics of fiber optic cable being used, whether in a manufacturing or laboratory environment or “in the field,” e.g., in a data center, a local area network (LAN) in a business, parts or components of a telecommunications network, etc. As some examples, a data center having thousands of links and fiber optic cables may be a service data center, such as, e.g., a Cloud Service Provider (CSP), or a business center, such as, e.g., a multi-tenant/colocation data center (MTDC), where testing and measurement of the fiber optic cables may be a critical element in meeting customer goals, performance objectives, standardization requirements, etc.

However, in some environments/deployments, the technician may need to perform the same tests/measurements on large numbers of fiber optic cables. For example, in a large data center, a technician may perform hundreds of the same tests/measurements on various fiber optic cables, which may make such work repetitive and burdensome. Accordingly, it may be appreciated that it may be beneficial to reduce the repetitive, burdensome nature of this work.

Moreover, each of these tests/measurements may involve multiple manipulations of the test device, as well as navigation through multiple screens and sub-screens on a display screen using a multitude of menus, etc., which may require in-depth training as well as a rigorous educational background. Accordingly, it may also be appreciated that the less training needed for the technicians performing these tests/measurements and, conversely, the greater automation and/or simplification of the tasks which the technician needs to perform, may be beneficial.

### BRIEF DESCRIPTION OF THE DRAWINGS

Features of the present disclosure are illustrated by way of example and not limited by or to the following figure(s), in which like numerals indicate like elements:

FIG. 1 illustrates a fiber optic cable test measurement source/meter pair of devices and the fiber optic cable, or Device Under Test (DUT), being tested, according to which examples of the present disclosure may be applied;

FIG. 2 illustrates a fiber optic cable test measurement source/meter pair of devices being used to test/measure a multitude of fiber optic cables, or Devices Under Test (DUTs), according to which examples of the present disclosure may be applied;

FIG. 3 illustrates the three different types of polarity for a 12-fiber Multi-fiber Push-On/Pull-Off (MPO) end connector fiber optic cable, which examples of the present disclosure may test for or otherwise measure;

FIG. 4 shows a display screen of results of a loss test performed on a 12-fiber MPO connector fiber optic cable by the complementary pair of fiber optic cable source/meter test devices in FIG. 1;

FIGS. 5A-5C shows examples of a portable fiber optic cable test device according to examples of the present disclosure;

FIG. 6 is a schematic block diagram illustrating the components of a portable fiber optic cable test device according to examples of the present disclosure; and

FIG. 7 is a flow diagram illustrating a method for a portable fiber optic cable test device to perform tests/measurements, according to examples of the present disclosure.

### DETAILED DESCRIPTION

For simplicity and illustrative purposes, the present disclosure is described by referring mainly to examples and embodiments thereof. In the following description, numerous specific details are set forth in order to provide a thorough understanding of the present disclosure. It will be readily apparent, however, that the present disclosure may be practiced without limitation to these specific details. In other instances, some methods and structures readily understood by one of ordinary skill in the art have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

As discussed above, users of fiber optic cable test devices may have to perform numerous, repetitive motions, button presses, and/or display interactions during the testing/measurement of a single fiber optic cable. Moreover, users of fiber optic cable test devices may have to perform thousands of these actions in a single day, which adds up to a non-trivial amount of time wasted by repetitive interactions with the fiber optic cable test device. Accordingly, it may be beneficial to have greater automation and/or simplification of these tasks which the users of fiber optic cable test devices need to perform. Moreover, it may be beneficial to require less training for the users of fiber optic cable test devices to perform tests/measurements.

According to examples of the present disclosure, a portable fiber optic cable test device may include a single physical button and a simple feedback/status light that together enable the user to perform tests/measurements without needing to interact with, e.g., the touchscreen of the portable fiber optic cable test device. In some examples, when the user presses the single physical button, the portable fiber optic cable test device steps through the workflow to perform the tests/measurements typically managed and controlled by multiple user interactions with the portable fiber optic cable test device. In some examples, the simple feedback/status light indicates the current state of the portable fiber optic cable test device as it automatically steps through the workflow to perform the tests/measurements. As long as no problems are encountered, no additional input is required, besides pushing the single physical button.

In some examples, the single physical button may be sized and positioned on fiber optic cable test device in such a way to enable the user to easily access it, and “muscle memory” may form over time and usage. In some examples, the simple feedback/status light may use a straightforward color code to indicate the current state of the portable fiber optic cable test device. For instance, a green light may indicate “measurement passed” or a blue light may indicate “connect next fiber.” In some examples, the workflow for Tier 1 data center testing/measurements may be driven by the single physical button and the light-based feedback.

Because problems that cause a complete stop to the series of tests, measurements, and/or procedures (which may be referred to herein as “intractable” or “workflow-stopping problems) occur fairly rarely, the workday/burden of users of the present portable fiber optic cable test device may be streamlined/optimized, thereby leading to overall efficiency gains. For instance, the user of the present portable fiber optic cable test device may test, for example, more than a hundred fiber optic cables, or “Device(s) Under Test” (DUTs), over the course of a workday by (i) connecting each fiber optic cable/DUT and (ii) pressing a single button, with perhaps only one or two intractable/workflow-stopping problems occurring over the course of the entire day, thereby greatly reducing time, effort, (the need for) training, etc., for each user. In some examples, other activities may be included, such as, e.g., visual inspection of the ferrule surfaces/end connectors of the fiber optic cables/DUTs, but even with such extra activity, the workflow is greatly streamlined/optimized.

According to one aspect of examples of the present disclosure, a portable fiber optic cable test device may include a port to connect to a fiber optic cable as a device under test (the fiber optic cable/DUT); an integrated feedback light/button to be physically pressed by a user and to display a plurality of indicia indicating a status of testing the fiber optic cable/DUT; and a processor operatively connected to the port and the integrated feedback light/button. As used herein, “indicia” should be understood as any indication, sign, and/or token which can be presented by the feedback light panel and associated with a meaning for the user of the portable fiber optic cable test device. In some examples, each of the plurality of indicia is a color, meaning that different colors have different meanings, e.g., the color green may mean the portable fiber optic cable test device is ready to initiate testing/measurement; the color red may mean the portable fiber optic cable test device has stopped testing/measurement because of a problem, etc. “Indicia” is used herein in the same manner as the term “media” may be understood in typical English parlance, i.e., the term “indicia” may be used herein instead of the Latin term “indicium” to indicate the singular, as well as indicating the plural, depending on context.

In some examples, the testing may include Tier 1 testing, including at least one of a loss test, a length test, or a polarity check. In some examples, the fiber optic cable/DUT is one of a 12-fiber or a 24-fiber Multi-fiber Push-On/Pull-Off (MPO) end connector fiber optic cable.

In some examples, the integrated feedback light/button may be a button and a feedback light source integrated together. The button may include at least one of a mechanical push-button which is physically moved by pressure from a user, a capacitive surface which may be capacitively coupled with a digit of a user, a resistive surface which detects pressure applied thereto, or any other touch-sensitive surface, while the feedback light source comprises at least one of a liquid crystal display (LCD) or a light emitting diode (LED).

In some examples, each of the plurality of indicia displayed by the integrated light feedback/button is a different color, gradation of a color, and/or other modulation of color visible to the user.

In some examples, the third indicia displayed by the integrated light feedback/button further indicates a progression of the testing being automatically performed on the fiber optic cable/DUT.

In some examples, the processor may further control the integrated light feedback/button to display a fourth indicia indicating the portable fiber optic cable test device has completed testing when the testing of the fiber optic cable/DUT has been completed.

According to one aspect of examples of the present disclosure, a portable fiber optic cable test device may include a port to connect to a fiber optic cable as a device under test (the fiber optic cable/DUT); a feedback light panel to display a plurality of indicia indicating a status of testing the fiber optic cable/DUT; a button to be physically pressed by a user; and a processor operatively connected to the feedback light panel, the button, and the port.

In some examples, the processor may be communicatively connected to a non-transitory computer-readable memory storing instructions executable by the processor, wherein, when executing the stored instructions, the processor controls the feedback light panel to display a first indicia indicating the portable fiber optic cable test device is not ready to perform testing when the fiber optic cable/DUT is not properly connected to the port; controls the feedback light panel to display a second indicia indicating the portable fiber optic cable test device is ready to perform testing when the fiber optic cable/DUT is properly connected to the port; controls, when the button is detected being depressed while the second indicia is being displayed, the portable fiber optic cable test device to automatically perform Tier 1 testing on the connected fiber optic cable/DUT, wherein the Tier 1 testing comprises a polarity check, a link test, and a length test of the fiber optic cable/DUT; and controls the feedback light panel to display a third indicia indicating the portable fiber optic cable test device is performing testing while the Tier 1 testing is being automatically performed on the fiber optic cable/DUT.

In some examples, the button may include any one or more of a mechanical push-button which is physically moved by pressure from a user, a capacitive button which may have capacitive coupling with a digit of a user, a resistive surface which detects pressure applied thereto, and/or any other touch-sensitive surface and/or technology suitable for usage with examples of the present disclosure, as would be understood by one of ordinary skill in the art in light of the examples of the present disclosure.

In some examples, each of the plurality of indicia displayed by the feedback light panel is a different color, gradation of a color, and/or other modulation of color visible to the user. In some examples, the fiber optic cable/DUT is one of a 12-fiber or a 24-fiber Multi-fiber Push-On/Pull-Off (MPO) end connector fiber optic cable. In some examples, the third indicia further may indicate a progression of the Tier 1 testing being automatically performed on the fiber optic cable/DUT. In such examples, the third indicia may indicate the progression of the Tier 1 testing by displaying a linear progress bar on the feedback light panel.

In some examples, the processor may further control the feedback light panel to display a fourth indicia indicating the portable fiber optic cable test device has completed testing when the Tier 1 testing of the fiber optic cable/DUT has been completed.

In some examples, the portable fiber optic cable test device may further include display screen to display information regarding testing the fiber optic cable/DUT, wherein the processor is operatively connected to the display screen.

In some examples, the processor may further control the feedback light panel to display a fifth indicia indicating the portable fiber optic cable test device has completed Tier 1 testing but also indicating that the user is to review a display screen disposed on the portable fiber optic cable test device, while also controlling the display screen to display recommendations for one or more actions for the user to perform to confirm the accuracy of the Tier 1 testing, when the Tier 1 testing of the fiber optic cable/DUT has been completed but potential problems are indicated with some or all of the Tier 1 testing.

In some examples, the processor may further control the feedback light panel to display a sixth indicia indicating the portable fiber optic cable test device has stopped testing before completion when an intractable problem arises in the Tier 1 testing of the fiber optic cable/DUT, while also controlling the display screen to display recommendations for one or more actions for the user to perform to correct the intractable problem.

According to one aspect of examples of the present disclosure, a method for a portable fiber optic cable test device to test a fiber optic cable as a device under test (the fiber optic cable/DUT) may include controlling, by a processor, a feedback light panel to display a first indicia indicating the portable fiber optic cable test device is not ready to perform testing when the fiber optic cable/DUT is not properly connected to the portable fiber optic cable test device; controlling, by the processor, the feedback light panel to display a second indicia indicating the portable fiber optic cable test device is ready to perform testing when the fiber optic cable/DUT is properly connected to the port; detecting, by the processor, if a button is depressed while the second indicia is being displayed; controlling, by the processor when the button is detected being depressed while the second indicia is being displayed, the portable fiber optic cable test device to automatically perform Tier 1 testing on the connected fiber optic cable/DUT; and controlling, by the processor, the feedback light panel to display a third indicia indicating the portable fiber optic cable test device is performing testing while the Tier 1 testing is being automatically performed on the fiber optic cable/DUT. In some examples, the Tier 1 testing may include a polarity check of the fiber optic cable/DUT, a link test of the fiber optic cable/DUT, and a length test of the fiber optic cable/DUT.

In some examples, each of the plurality of indicia may be a different color. In some examples, the fiber optic cable/DUT may be one of a 12-fiber or a 24-fiber Multi-fiber Push-On/Pull-Off (MPO) end connector fiber optic cable. In some examples, the third indicia further may indicate a progression of the Tier 1 testing being automatically performed on the fiber optic cable/DUT. In such examples, the third indicia may indicate the progression of the Tier 1 testing by displaying a linear progress bar on the feedback light panel.

In some examples, the method may further include controlling, by the processor, the feedback light panel to display a fourth indicia indicating the portable fiber optic cable test device has completed testing when the Tier 1 testing of the fiber optic cable/DUT has been completed.

In such examples, the method may further include controlling, by the processor, the feedback light panel to display a fifth indicia indicating the portable fiber optic cable test device has completed Tier 1 testing but also indicating that the user is to review a display screen disposed on the portable fiber optic cable test device; and controlling, by the processor, the display screen to display recommendations for one or more actions for the user to perform to confirm the accuracy of the Tier 1 testing, when the Tier 1 testing of the fiber optic cable/DUT has been completed but potential problems are indicated with some or all of the Tier 1 testing.

In such examples, the method may further include controlling, by the processor, the feedback light panel to display a sixth indicia indicating the portable fiber optic cable test device has stopped testing before completion when an intractable problem arises in the Tier 1 testing of the fiber optic cable/DUT; and controlling, by the processor, the display screen to display recommendations for one or more actions for the user to perform to correct the intractable problem.

In such examples, the method may further include detecting, by the processor, if the fiber optic cable/DUT is disconnected from the portable fiber optic cable test device while the fourth indicia indicating the portable fiber optic cable test device has completed testing of the fiber optic cable/DUT is being displayed; and controlling, by the processor when the fiber optic cable/DUT is detected being disconnected from the portable fiber optic cable test device, the feedback light panel to display the first indicia indicating the portable fiber optic cable test device is not ready to perform testing until a next fiber optic cable/DUT is properly connected to the portable fiber optic cable test device.

### I. Fiber Optic Cable Test Source/Meter Pair of Devices

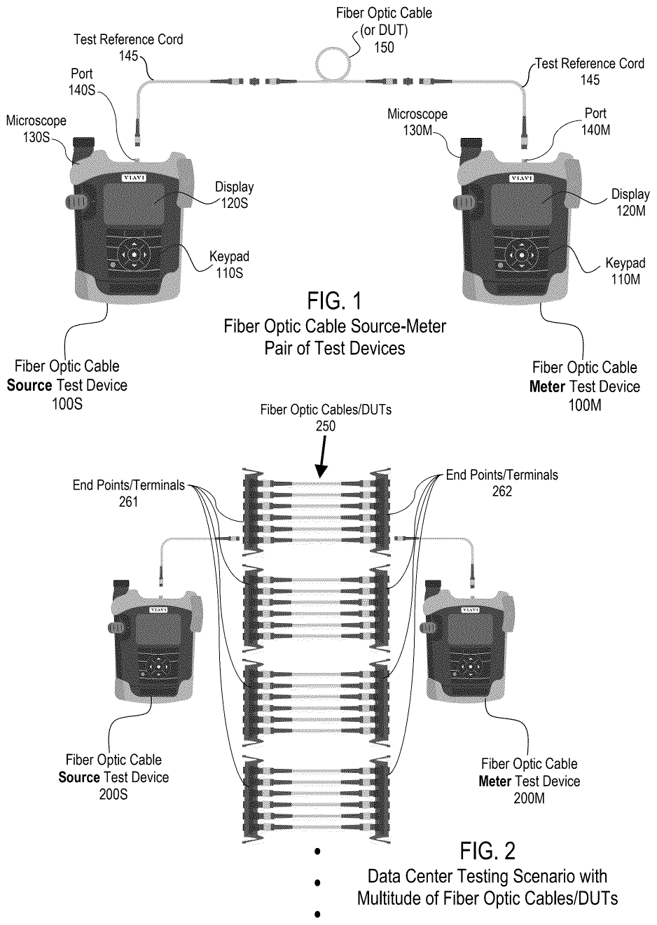

FIG. 1 illustrates a fiber optic cable test measurement source/meter pair of devices and the fiber optic cable, or Device Under Test (DUT), being tested, according to which examples of the present disclosure may be applied. The fiber optic cable test measurement source/meter pair of devices and the fiber optic cable, or DUT, shown in FIG. 1 are provided to illustrate the explanation below of this example, and may omit aspects, features, and/or components not germane to examples of the present disclosure, as would be understood by one of ordinary skill in the art; moreover, the components shown in FIG. 1 may not be shown in accurate aspect and/or ratio of relative sizes. For instance, a fiber optic cable or Device Under Test (DUT) 150 is represented in FIG. 1 as a coiled cable indicating that the length is not defined (i.e., the fiber optic cable or Device Under Test (DUT) 150 may be any length suitable for its operation and usage), and its relative length as shown in FIG. 1 to the other objects in FIG. 1 in no way approximates its range of possible relative lengths in relation to the other objects in FIG. 1. In other words, the sizes, proportions, relative aspects, etc., of the elements shown in FIG. 1 are not necessarily intended to be accurate, as would be understood by one of ordinary skill in the art, but are rather intended to illustrate and aid in the explanation and description of the examples of the present disclosure.

FIG. 1 shows a fiber optic cable source test device 100S, a fiber optic cable meter test device 100M, and a fiber optic cable or Device Under Test (DUT) 150. Each of the fiber optic cable source test device 100S and the fiber optic cable meter test device 100M are connected, via port 140S and 140M, respectively, to the fiber optic cable/DUT 150 by a test reference cord 145 (since the test reference cord 145 on both the source side and the meter side are substantially identical, they are both identified here with the reference numeral 145). In some examples, the fiber optic cable source test device 100S and the fiber optic cable meter test device 100M may have substantially similar exterior appearances, such as is the case in FIG. 1; in other examples, the exterior appearances of the fiber optic cable source test device 100S and the fiber optic cable meter test device 100M may be substantially dissimilar. In any event, the fiber optic cable source test device 100S and the fiber optic cable meter test device 100M require different internal components, as the fiber optic cable source test device 100S requires one or more internal light sources which project light out of port 140S for testing/measuring the fiber optic cable/DUT 150, while the fiber optic cable meter test device 100M requires one or more light sensors/meters for receiving and measuring the light through port 140M from the fiber optic cable/DUT 150. As would be understood by one of ordinary skill in the art, in some examples, both the fiber optic cable source test device 100S and the fiber optic cable meter test device 100M may have a variety of light sources and a variety of light sensors/meters serving a variety of purposes.

As shown in FIG. 1, each of the fiber optic cable source test device 100S and the fiber optic cable meter test device 100M may have a keypad 110S and keypad 110M, respectively; a display 120S and a display 120M, respectively; a microscope 130S and a microscope 130M, respectively; and the port 140S and the port 140M, respectively, which may connect, via the test reference cord 145, to the fiber optic cable/DUT 150 for purposes of testing and measurement. The microscope 130S/130M may be utilized, using a suitable fiber optic cord attachment (not shown in FIG. 1), to view the end connectors of the fiber optic cable/DUT 150 to detect, for example, particulate matter (“dirt”) on the ferrule surface(s) of the optic fibers in the fiber optic cable/DUT 150. It may be noted that the complementary pair of the fiber optic cable source test device 100S and the fiber optic cable meter test device 100M in FIG. 1 resemble a VIAVI SmartClass™ Fiber MPOLx test set; however, as noted above, the pair of the fiber optic cable source test device 100S and the fiber optic cable meter test device 100M in FIG. 1 are examples for illustrative purposes only and are not limiting in any way to the present disclosure.

In some examples, the fiber optic cable/DUT 150 may be a fiber optical cable containing a multitude of individual optical strands, where each strand or fiber is capable of light transmission independently from the rest. In some examples, the fiber optic cable/DUT 150 may be a 12-fiber or 24-fiber Multi-fiber Push-On/Pull-Off (MPO) connector fiber optic cable (sometimes referred to as the Multi-Position Optical (MPO) end connector fiber optic cable), as defined by International Electrotechnical Commission (IEC) standard 61754-7; however, the fiber optic cable/DUT 150 of the present disclosure is not limited to a type of MPO connector fiber optic cable, but may be any type of fiber optic cable, containing any number of strands/fibers. In some examples, any optical fiber cable according to a standard by the American National Standards Institute (ANSI), which accredits the Telecommunication Industry Association (TIA), may be used in accordance with examples of the present disclosure, including any past, present, and/or future versions of the ANSI/TIA-568.3 Optical Fiber Cabling Components standard, which defines cabling types, distances, connectors, cable system architectures, cable termination standards and performance characteristics, cable installation requirements and methods of testing installed cabled cable. ANSI/TIA-568.3-E is hereby incorporated herein by reference in its entirety. In some examples, the fiber optic cable/DUT 150 of the present disclosure may be in accordance with other standards set by ANSI, TIA, and/or other organizations such as, e.g., the International Electrotechnical Commission (IEC) (sometimes with the International Organization for Standardization (IOS/IEC)) or the International Telecommunications Union (ITU). For instance, the fiber optic cable/DUT 150 of the present disclosure may be any fiber optic cable in the IOS/IEC 11801-1 series, the IEC 60793-2-10 series, the TIA-568.3-D series, the TIA/EIA 492AAAx series, and/or in accordance with any ITU-T standards (such as, e.g., G.651.1). Examples of the present disclosure are expressly directed to any past, present, and/or future fiber optic cables (including any part of the fiber optic cable, such as, e.g., any type of end connector of the fiber optic cable, etc.).

Accordingly, the term “end connector” may be used herein to refer to any type of connector used in fiber optics, including, but not limited to, any end connector for a fiber optic cable according to any EIA/TIA end connector standard, as listed in the 604 series (e.g., “TIA-604-XX”) and/or identified by a Fiber Optic Connector Intermateability Standard (FOCIS) document, and/or any International Electrotechnical Commission (IEC) standard; the aforementioned MPO connector (IEC 61754-7, having and/or using any number of fibers/strands, e.g., 12 fiber FOCIS-5/TIA-604-5, 16 fiber FOCIS-18/TIA-604-18, 24 fiber, etc.); a simplex end connector; any type of Polished Connector (PC), such as, e.g., an Angled PC (APC), an Ultra PC, etc. ; a Straight Terminus (ST) end connector (FOCIS-2/TIA-604-2); a Subscriber Connector or Snap-in Connector (SC) (FOCIS-3/TIA-604-3, IEC 61754-4, etc.); a Fiber Connector/Ferrule Connector/Fiber Channel (FC) (FOCIS-4/TIA-604-4); a Lightwave Connector (LC) (FOCIS-10/TIA-604-10); an LX-5 end connector (FOCIS-13/TIA-604-13); an MU end connector (FOCIS-17/TIA-604-17); a Mechanical Transfer (MT) jack/connector (EIA/TIA 604-5); an MT-RJ end connector (e.g., FOCIS-12/TIA-604-12, IEC 61754-18, etc.); an E-2000 end connector (IEC 61754-15); an F-3000 end connector (IEC 61754-20); a Sub Miniature A (SMA) end connector (e.g., IEC 61754-2), or any other IEC/IEA/TIA standard interface/connector for fiber optics, and/or any other form of end connector suitable for use with fiber optics, as would be understood by one of ordinary skill in the art. As additional examples, examples of the present disclosure are intended to cover the testing, measurement, and/or other verification of interfaces such as, e.g., Small Form-factor Pluggable (SFP), including, e.g., cSFP, SFP+, SFP28, SFP56, SFP-DD, SFP112, SFP-DD112, etc. ; Quad Small Form-factor Pluggable (QSFP), including, e.g., QSFP+, QSFP28, QSFP56, QSFP112, QSFP-DD, etc. ; Octal Small Form-factor Pluggable (OSFP); and what is sometimes referred to as Very Small Form Factor (VSFF) multi-fiber optical connectors, such as, e.g., the MMC series of connectors which may have alignment structures to match the ferrules of the various MPO, MT, and other end connector interface.

Accordingly, the terms “fiber optic cable,” a “device under test,” a “DUT,” “fiber optic cable/DUT,” and/or any variations thereof as used herein may include, but are not limited to, any of the examples specifically referred to above. As would be understood by one of ordinary skill in the art in light of the present disclosure, examples of the present disclosure are intended to cover any testing, measurements, and/or verification of any past, present, and/or future versions, permeations, and/or different classifications of fiber optic cables and/or their end connectors (including proprietary fiber optic cables and/or end connectors such as, e.g., MTP and MMC end connectors).

FIG. 2 illustrates a fiber optic cable test measurement source/meter pair of devices being used to test/measure a multitude of fiber optic cables, or Devices Under Test (DUTs), according to which examples of the present disclosure may be applied. The fiber optic cable test measurement source/meter pair of devices and the multitude of fiber optic cables/DUTs shown in FIG. 2 are provided to illustrate the description below of this example, and may omit aspects, features, and/or components not germane to examples of the present disclosure, as would be understood by one of ordinary skill in the art; moreover, the components shown in FIG. 2 may not be shown in accurate aspect and/or ratio of relative sizes. For instance, similarly to FIG. 1, the fiber optic cables/DUTs shown in FIG. 2 may be of any suitable length for their deployment and/or usage, and, by contrast to what is shown in FIG. 2, the fiber optic cables/DUTs may have a multitude of different lengths, and/or may have different directions, aspects, and/or dispositions relative to each other. In other words, the sizes, proportions, relative aspects, etc., of the elements shown in FIG. 2 are not necessarily intended to be accurate, as would be understood by one of ordinary skill in the art, but are rather intended to illustrate and aid in the explanation and description of the examples of the present disclosure.

FIG. 2 shows a source/meter pair of test devices similar to those shown in FIG. 1, i.e., a fiber optic cable source test device 200S and a fiber optic cable meter test device 200M, with a large multitude of fiber optic cables/DUTs 250. Groups of the multitude of fiber optic cables/DUTs 250 may have end points/terminals 261 and 262, where the fiber optic cable source test device 200S may be located in the vicinity of the end points/terminals 261 and the fiber optic cable meter test device 200M may be located in the vicinity of the end points/terminals 262. In some examples, the fiber optic cables/DUTs 250 may form one or more of a link, channel, a backbone, etc., as would be understood by one of ordinary skill in the art. In some examples, the end points/terminals 261 and 262 may include one or more of a cassette, a patch panel, a routing unit in a rack, etc., as would be understood by one of ordinary skill in the art. As mentioned above, although depicted side by side in orderly rows in FIG. 2, the end points/terminals 261 and 262 may be in different rooms within a building, and/or in different buildings on a campus, and/or on different sides of a town or city, etc., as would be understood by one of ordinary skill in the art.

In some examples, FIG. 2 may be a data center where there are hundreds or thousands of fiber optic cables/DUTs 250 to be tested and/or measured and the end points/terminals 261 and 262 of the different fiber optic cables/DUTs 250 may be located in different rooms and/or on different floors of the data center. In such examples, the users of the pair of fiber optic cable source test device 200S and fiber optic cable meter test device 200M may have to repeat the same set of measurements and/or tests hundreds of times.

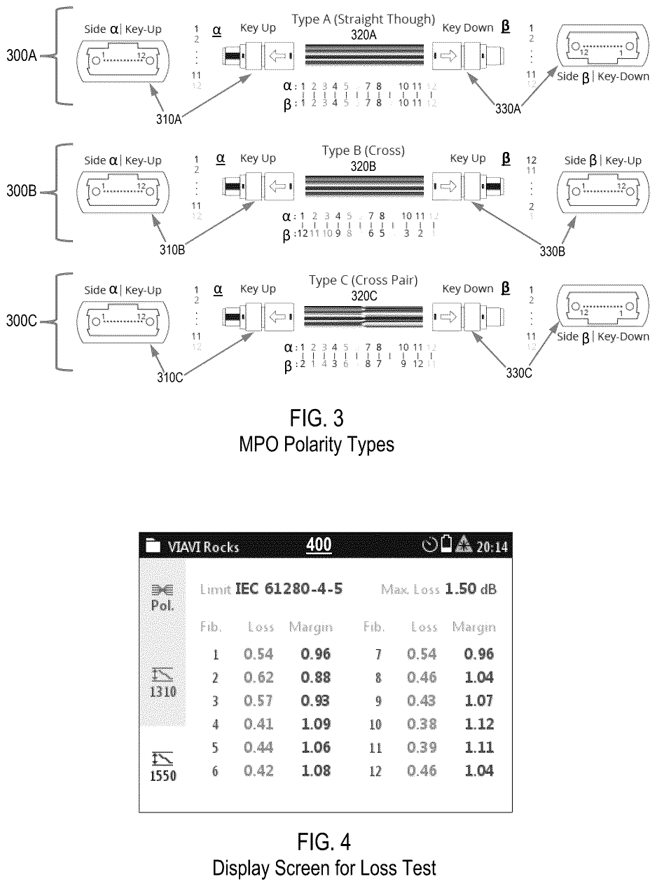

FIGS. 3 & 4 provide non-limiting illustrative examples of the types of measurements, testing, and results which may be performed/found by a complementary pair of source/meter test devices, such as, e.g. the fiber optic cable source test device 100S and the fiber optic cable meter test device 100M in FIG. 1.

The testing and measurements done depend on the type of fiber optic cables/DUTs, their deployment/usage, their configuration, the standards being applied, etc., as would be known by one of ordinary skill on the art. In some examples, Tier 1 testing of a fiber optic system according to the ANSI/TIA-568.3 standard may be performed, which includes link attenuation testing (or “loss” testing), link length testing, and a polarity check.

FIG. 3 illustrates the three different types of polarity for a 12-fiber MPO connector fiber optic cable, for which examples of the present disclosure may test or otherwise measure. In each row 300 of FIG. 3, a different type of polarity for a communication link is illustrated, with an end connector 310 on the left-hand side (labelled Side α) of the communication link with its fibers in the center and an end connector 330 on the right-hand side (labelled Side β). There are two views of each end connector in each row: first (starting from the left), an end view of the end connector 310, which shows all 12 fiber ends in a row 1 through 12, then a top view of the end connector 310 on Side α, then on the other Side β, a top view of the end connector 330, and an end view of the end connector 330 at the end of the row. In the middle of each row, the polarity type 320 is identified above the fibers and, below the fibers, the correspondence between the 12 fiber ends on Side α and the 12 fiber ends on Side β are shown.

More specifically, in row 300A of FIG. 3, Type A (Straight Through) Polarity 320A is illustrated, where each of the ends of the 12 fibers of the end connector 310A on Side α match the ends of the 12 fibers of the end connector 330A on Side β (i.e., fiber 1 to fiber 1, fiber 2 to fiber 2, . . . ). In row 300B of FIG. 3, Type B (Cross) Polarity 320B is illustrated, where each of the ends of the 12 fibers of the end connector 310B on Side α cross over to the opposite ends of the 12 fibers of the end connector 330B on Side β (i.e., fiber 1 to fiber 12, fiber 2 to fiber 11, . . . ). In row 300C of FIG. 3, Type C (Cross Pair) Polarity 320C is illustrated, where each pair of the ends of the 12 fibers of the end connector 310C on Side α switches over to the opposite ends of the matching pair of the 12 fibers of the end connector 330C on Side β (i.e., fiber 1 to fiber 2, fiber 2 to fiber 1, . . . ).

In some examples, the complementary pair of source/meter test devices 100S/100M may be employed to determine the polarity of the fiber optic cable/DUT 150 to which they are connected, which would correspond to one of the types shown in FIG. 3, if the fiber optic cable/DUT 150 was a 12-fiber MPO connector. The 3 types of polarity are defined differently for a 24-fiber MPO end connector, which consists of 2 rows of 12 fibers. A more complete definition of polarity may be found in ANSI/TIA-568.3.

FIG. 4 shows a display screen 400 for results of a loss test performed on a 12-fiber MPO connector fiber optic cable by the complementary pair of source/meter test devices 100S/100M of FIG. 1. As shown in FIG. 4, loss values and margins are measured and listed for each of the 12 fibers in the 12-fiber MPO connector fiber optic cable. As indicated by display screen 400 of FIG. 4, IEC standard 61280-4-5 is being employed. IEC 61280-4-5 is for, inter alia, the measurement of attenuation of light transmission (loss test), the determination of link length of installed optical fiber cabling (length test), and the determination of polarity of optical fiber cables with MPO end connectors, and is also hereby incorporated by reference herein in its entirety. As also indicated by display screen 400 of FIG. 4, two or more different wavelengths of light may be transmitted on the 12-fiber MPO connector fiber optic cable, as shown by the “1310” (nm.) and “1550” (nm.) on the left-hand side of the display.

During the testing and verification of a single fiber optic cable, the user may have to step through, and possibly review/assess the contents of, a series of screens like the display screen 400 in FIG. 4.

### II. Examples of Fiber Optic Cable Test Devices (Sources and/or Meters) with Single-Button Workflow and a Feedback Status Light

As noted above, fiber optic cabling is a continually fast-growing and often critical part of almost every communication system infrastructure and, as such, it is beneficial that test devices for fiber optic cable require less training, knowledge, and skill so that people without, for example, a rigorous engineering education/background may be enlisted to perform these tests. However, the display screen 400 of FIG. 4 indicates a possible problem for such unskilled labor in interpreting and understanding the complexity and meaning of the testing and its results. Moreover, FIG. 4 points to the extent of the problem as it is only one of the many sub-screens which must be navigated through in order to perform the testing/measurements.

Accordingly, it is desirable to simplify the usage of the portable fiber optic cable test device when performing the many various processes, testing methods and procedures, while also reducing the burdensome nature of the users'overall daily workflow where such various processes, testing methods and procedures are repeatedly performed over the course of a day. As noted above, the testing and/or verification of a single fiber optic cable may involve stepping through a series of interactions and reviewing/assessing the contents of a series of screens (like the display screen 400 in FIG. 4)—while over the course of a single day, this same series of testing, measurements, and/or procedures may be performed hundreds of times by the same user.

According to examples of the present disclosure, a portable fiber optic cable test device is provided which both simplifies its usage when performing the many various processes, testing methods and procedures and reduces the burdensome repetitiveness of the users'overall daily workflow. In some examples, a single button is disposed on the portable fiber optic cable test device which, when physically pressed by the user, initiates a series of processes, procedures, and tests, while a single status monitor light panel provides simple and direct feedback regarding the status of the series of various processes, procedures, and tests, by displaying, for example, one color to indicate ongoing progress, another color to indicate the series of various processes, procedures, and tests were completed successfully, and a third color to indicate that one or more of the series of various processes, procedures, and tests were not completed successfully (e.g., a test was not passed, a procedure was not able to be completed, etc.).

The examples discussed below refer to a mechanical button (such as, e.g., a push-button which is physically moved by pressure from a user); however, examples of the present disclosure are not so limited and may include any touch-sensitive surface and/or technology suitable for usage with examples of the present disclosure, as would be understood by one of ordinary skill in the art in light of the examples of the present disclosure. For instance, in some examples, the button may be a capacitive button which capacitively couples with a digit of a user and/or a resistive surface which detects pressure applied thereto.

Because “intractable” or “workflow-stopping” problems (i.e., problems that cause a complete stop to the series of tests, measurements, and/or procedures) occur fairly rarely, the workday/burden of users of the present portable fiber optic cable test device (source/meter) may be streamlined/optimized, thereby leading to overall efficiency gains. In some examples, the user of the present portable fiber optic cable test device may test, e.g., more than a hundred fiber optic cables/DUTs over the course of a workday by (i) connecting each fiber optic cable/DUT and (ii) pressing a single button—with perhaps no intractable/workflow-stopping problems occurring over the course of the entire day, or just one or two, thereby greatly reducing time, effort, training, etc. In some examples, other activities may be included, such as, e.g., visual inspection of the ferrule surfaces/end connectors of the fiber optic cables/DUTs, but even with such extra activity, the workflow is greatly streamlined/optimized by the present portable fiber optic cable test device (source/meter).

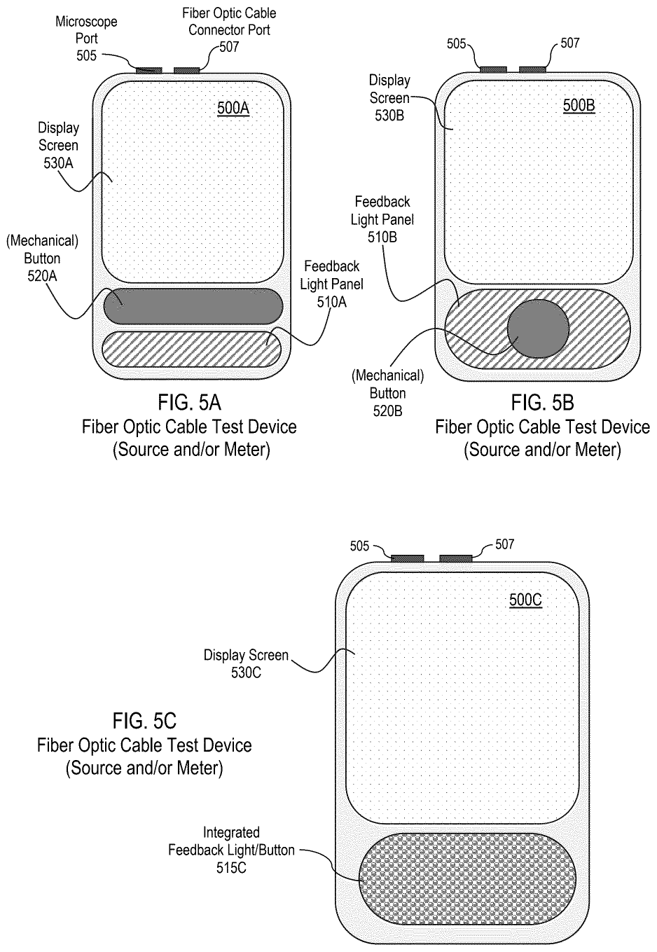

FIGS. 5A-5C shows examples of a portable fiber optic cable test device according to examples of the present disclosure. FIGS. 5A-5C are provided to illustrate the explanation below of examples of the present disclosure, and may omit aspects, features, and/or components not germane to examples of the present disclosure, which would be understood by one of ordinary skill in the art; in other words, FIGS. 5A-5C are not necessarily intended to be pictorially accurate, but rather are intended to illustrate and aid in the explanation and description of the examples of the present disclosure, as would be understood by one of ordinary skill in the art. The term “portable fiber optic cable test device 500” may be used herein to refer collectively to any portable fiber optic cable test device implemented in accordance with examples of the present disclosure, including, but not limited to, the portable fiber optic cable test devices 500A, 500B, and 500C in FIGS. 5A, 5B, and 5C, respectively.

FIGS. 5A and 5B show a portable fiber optic cable test device 500A and 500B, respectively, which includes a feedback light panel 510A/B, a single button 520A/B (which may be mechanical), and a display screen 530A/B. FIG. 5C shows a portable fiber optic cable test device 500C, which includes a display screen 530C and an integrated feedback light/button 515C, where the functions of the single button and the feedback light are combined, as discussed in further detail below.

The portable fiber optic cable test device 500 in each of FIGS. 5A, 5B, and 5C may be a power source test device (i.e., having one or more light sources for providing one or more test inputs), a meter test device (i.e., having a one or more sensors/meters for testing/measuring one or more test outputs), or a combination source/meter test device capable of both providing test input and measuring test output. If only one of a power source test device or a meter test device, the portable fiber optic cable test device 500 must be paired with its complementary test device in order to perform testing/measurements. Even if only one of a power source test device or a meter test device, the portable fiber optic cable test device 500 may have both one or more light sources and one or more light sensors/meters to perform a variety of operations/tasks. Similarly to the test devices 100S/M in FIG. 1, each one of a complementary pair of portable fiber optic cable test devices 500, where one serves as the power source and the other serves as the sensor/meter, may have a substantially similar exterior appearance.

The single (mechanical) button 520A & 520B and the integrated feedback light/button 515C in FIGS. 5A & 5B and 5C, respectively, may be depressed by a user to initiate a series of checks, processes, measurements, tests, and/or procedures (which require no intervention by the user), while the feedback light panel 510A/B and/or integrated feedback light/button 515C in FIG. 5A/B and 5C, respectively, may provide indicia of the status of the series of checks, processes, measurements, tests, and/or procedures initiated by the user. In some examples, the feedback light panel 510A/B and/or integrated feedback light/button 515C may provide the indicia by displaying a single color, where, for example, a first color may indicate the series of checks, processes, measurements, tests, and/or procedures initiated by the user are proceeding, a second color may indicate the series of checks, processes, measurements, tests, and/or procedures initiated by the user has ended successfully, and a third color may indicate the portable fiber optic cable test device 500 may be detached for the current fiber optic cable/DUT and/or attached to the next fiber optic cable/DUT. In other examples, the feedback light panel 510A/B and/or integrated feedback light/button 515C may provide the indicia using more or less colors, and/or with one or more light patterns, etc.—some of these and other examples are discussed in more detail below.

Similarly to the term “portable fiber optic cable test device 500,” the term “feedback light panel 510” may be used herein to refer collectively to any feedback light panel implemented in accordance with examples of the present disclosure, including, but not limited to, the feedback light panels 510A and 510B in FIGS. 5A and 5B, respectively, as well as the integrated feedback light/button 515C of FIG. 5C (insofar as it functions as a feedback light panel); the term “button 520” may be used herein to refer collectively to any button implemented in accordance with examples of the present disclosure, including, but not limited to, the single (mechanical) buttons 520A and 520B in FIGS. 5A and 5B, respectively, as well as the integrated feedback light/button 515C of FIG. 5C (insofar as it functions as a button); and the term “display screen 530” may be used herein to refer collectively to any display screen implemented in accordance with examples of the present disclosure, including, but not limited to, the display screens 530A, 530B, and 530C in FIGS. 5A, 5B, and 5C, respectively.

The display screen 530 in each of FIGS. 5A, 5B, and 5C may be implemented by any type of flat screen presentation device, including, but not limited to, a liquid crystal display (LCD), one or more light emitting diodes (LEDs), etc., as would be understood by one of ordinary skill in the art, and may also include a touchscreen capable of receiving input. In some examples, the display screen 530 in each of FIGS. 5A, 5B, and 5C may display information concerning any of the checks, processes, measurements, tests, and/or procedures which the portable fiber optic cable test device 500 is capable of performing; information concerning the series of checks, processes, measurements, tests, and/or procedures initiated by depressing the (mechanical) button 520A/B and/or integrated feedback light/button 515C; and/or information concerning the indicia provided by the feedback light panel 510A/B and/or integrated feedback light/button 515C.

Each of the portable fiber optic cable test devices 500 shown in FIGS. 5A, 5B, and 5C may include a microscope port 505 and a fiber optic cable connector port 507. The microscope port 505 in each of FIGS. 5A, 5B, and 5C may serve as a connector with a separate microscope unit which may be utilized to inspect the, e.g., ferrule ends of the fiber optic(s) in the fiber optic cable. In other examples, such a microscope may be implemented in the portable fiber optic cable test device 500, similarly to the test devices 100S/M in FIG. 1. However, separating out the microscope, such as is done in the examples of FIGS. 5A, 5B, and 5C, makes the portable fiber optic cable test devices 500 even more portable. The fiber optic cable connector port 507 in each of FIGS. 5A, 5B, and 5C may serve as a connector with any number of test connector cords suitable for connection with a large variety of end connectors of fiber optic cables, in a manner similar to the test devices 100S/M in FIG. 1.

It should be appreciated that the various dispositions/implementations of the feedback light panel 510A/B, the single (mechanical) button 520A/B, and the display screen 530A/B in each of the portable fiber optic cable test devices 500A/B in FIGS. 5A and 5B and the disposition/implementation of the display screen 530C and the integrated feedback light/button 515C the portable fiber optic cable test device 500C in FIG. 5C (e.g., their locations and their relative locations vis-à-vis each other; their dimensions and their relative dimensions vis-à-vis each other; their shapes and their relative shapes vis-à-vis each other; etc.) are merely examples for purposes of explanation and illustration of the present disclosure, other dispositions/implementations of the feedback light panel 510A/B, the single (mechanical) button 520A/B, the integrated feedback light/button 515C, and the display screen 530 are possible in a portable fiber optic cable test device in accordance with the present disclosure, as explained, described, and/or claimed herein. For instance, the feedback light panel, the single (mechanical) button, and the display screen may be further integrated into a single operational unit; any of the feedback light panel 510A/B, the integrated feedback light/button 515C, the single (mechanical) button 520A/B, and/or the display screen 530 may extend to other surfaces on the portable fiber optic cable test device 500, and/or be disposed on other surfaces, besides the top surface as shown in FIGS. 5A-5C, as would be understood by one of ordinary skill in light of the examples of the present disclosure.

FIG. 5A is a simplified block diagram of a front surface of a portable fiber optic cable test device 500A (which may be a source and/or meter) where a display screen 530A is disposed at the top of the front surface of the portable fiber optic cable test device 500A, a feedback light panel 510A is disposed at the bottom of the front surface of the portable fiber optic cable test device 500A, and a (mechanical) button 520A is disposed between the display screen 530A and the feedback light panel 510A on the front surface of the portable fiber optic cable test device 500A. A microscope port 505 and a fiber optic cable connector port 507 may be disposed on the top surface of the portable fiber optic cable test device 500A. As used herein, “front,” “top” and “bottom” refer to the orientation in which the user is intended to hold the portable fiber optic cable test device 500, e.g., how the display screen 530 may be viewed properly, how the portable fiber optic cable test device 500 may be held properly when in use, etc. ; however, in some examples, the portable fiber optic cable test device 500 may be held in more than one orientation, or possibly in any orientation, in which case the display screen 530 may change its orientation to correspond to however the user is holding the portable fiber optic cable test device 500.

It may be appreciated that the (mechanical) button 520A in FIG. 5A extends across the width of the front surface, thus enabling both left-handed and right-hand users to easily access and depress the (mechanical) button 520A. The feedback light panel 510A in FIG. 5A also extends across the width of the front surface, thus making it fairly easy to view from any angle or viewing orientation. In some examples, the button 520 may take the form of two mechanical buttons, each one on an opposite side of the display screen 530, so as to be easily accessible to the user. In some examples, one or both of the feedback light panel 510 and the button 520 may extend, in part, onto a side surface of the portable fiber optic cable test device 500. In some examples, one or both of the feedback light panel 510 and the button 520 may be disposed on a side surface of the portable fiber optic cable test device 500.

In some examples, the indicia utilized by the feedback light panel 510 may be the displaying of a single color (at a time) to indicate the current status, whether that status be, for example, any one or more of: ready (for user to depress the button 520 to initiate the series of checks, processes, measurements, tests, and/or procedures); in progress (indicating the series of checks, processes, measurements, tests, and/or procedures are presently being performed); successful completion (of the series of checks, processes, measurements, tests, and/or procedures); problematic/partial completion (of the series of checks, processes, measurements, tests, and/or procedures, in which case the user may access the display screen 530 to determine what went wrong); immediate problem (requiring the user's immediate attention and resolution before continuing, in which case the user may access the display screen 530 to determine what needs to be done); and/or different colors to indicate different gradations of status (e.g., a pale yellow to indicate ready to attach to the fiber optic cable/DUT; a medium yellow to indicate ready to confirm another test device is at the other end of the fiber optic cable/DUT to which the test device has connected; and a strong/bright yellow to indicate the fiber optic cable/DUT is ready to be tested, i.e., the button 520 may be depressed now, after confirming a successful connection with the other test device is at the other end of the fiber optic cable/DUT).

In some examples, the indicia utilized by the feedback light panel 510 may be displaying more than one color, and/or gradations of a color (or lack of any displayed color), at a time. In such an example, the feedback light panel 510 may appear as a progress bar, indicating, e.g., how far the series of checks, processes, measurements, tests, and/or procedures has gotten and how far there is to go, by, e.g., lighting up a linear portion of the feedback light panel 510 roughly equivalent to the percentage of the series of checks, processes, measurements, tests, and/or procedures completed and not lighting the remaining linear portion of the feedback light panel 510 (which would be roughly equivalent to the percentage of time remaining to complete the series of checks, processes, measurements, tests, and/or procedures). In such an example, the linear progression might be indicated by a progress bar having two different colors, or having multiple gradations of a single color.

FIG. 5B is a simplified block diagram of a front surface of a portable fiber optic cable test device 500B (which may be a source and/or meter) where a display screen 530B is disposed at the top of the front surface of the portable fiber optic cable test device 500B, a feedback light panel 510B is disposed beneath the display screen 530B at the bottom of the front surface of the portable fiber optic cable test device 500B, and a (mechanical) button 520B is disposed inside the feedback light panel 510B. Similarly to FIG. 5A, a microscope port 505 and a fiber optic cable connector port 507 may be disposed on the top surface of the portable fiber optic cable test device 500B.

As shown in FIG. 5B, the (mechanical) button 520B is in the form of a circle and is disposed in the center of the feedback light panel 510B; in other examples, the (mechanical) button 520B may take another shape (such as, e.g., a rectangular oval similar to the (mechanical) button 520A in FIG. 5A) and may be disposed differently inside the feedback light panel 510B (such as, e.g., extending across and almost of the feedback light panel 510B). Although not limited thereto, the example in FIG. 5B may be particularly suited to using a single color as the indicia of status shown by the feedback light panel 510B.

As shown in FIG. 5B, the (mechanical) button 520B is disposed within the feedback light panel 510B; in other examples, the (mechanical) button 520B may be disposed outside and surrounding the feedback light panel 510B—thereby enabling easier ambidextrous access to the (mechanical) button 520B as it will extend across the front surface of the portable fiber optic cable test device 500B, similar to the (mechanical) button 520A in FIG. 5A.

FIG. 5C is a simplified block diagram of a front surface of a portable fiber optic cable test device 500C (which may be a source and/or meter) where a display screen 530C is disposed on the front surface of the portable fiber optic cable test device 500C above the integrated feedback light/button 515C disposed at the bottom of front surface. Similarly to FIGS. 5A and 5B, a microscope port 505 and a fiber optic cable connector port 507 may be disposed on the top surface of the portable fiber optic cable test device 500C.

The portable fiber optic cable test device 500C in FIG. 5C is similar to the portable fiber optic cable test devices 500A/B in FIG. 5A/B and provides an example illustrating the variety of ways that the feedback light panel 510 and the (mechanical) button 520 may be implemented—including, in this case, integrated into a single integrated feedback light/button 515C—and that the feedback light panel 510A/B and the (mechanical) button 520A/B and/or the integrated feedback light/button 515C may be disposed in almost any location on the portable fiber optic cable test device 500C suitable for their individual purposes, as would be understood by one of ordinary skill in the art. In some examples, the integrated feedback light/button 515C may take the form of two mechanical buttons, each one on an opposite side of the display screen 530C, so as to be easily accessible to the user. In some examples, the integrated feedback light/button 515C may extend, in part, onto a side surface of the portable fiber optic cable test device 500C. In some examples, the integrated feedback light/button 515C may be disposed on a side surface of the portable fiber optic cable test device 500C.

The integrated feedback light/button 515C in FIG. 5C extends across the width of the front surface, thus enabling both left-handed and right-hand users to easily access and depress the integrated feedback light/button 515C, as well as making it fairly easy for the user to see the status/indicia indicated by the integrated feedback light/button 515C from any angle or viewing orientation. In some examples, the indicia utilized by the integrated feedback light/button 515C may be the displaying of a single color (at a time) to indicate the current status, whether that status be, for example, any one or more of:
ready (for user to depress the integrated feedback light/button 515C to initiate the series of checks, processes, measurements, tests, and/or procedures);
not ready (e.g., the fiber optic cable/DUT is not yet connected);
performing testing and/or testing in progress (indicating the series of checks, processes, measurements, tests, and/or procedures are presently being performed);
testing completed (e.g., successful completion of the series of checks, processes, measurements, tests, and/or procedures);
problematic/partial completion (of the series of checks, processes, measurements, tests, and/or procedures, in which case the user may view and/or otherwise access the display screen 530C to determine what went wrong);
testing paused and/or stopped (e.g., there is an intractable/workflow-stopping problem requiring the user's immediate attention and resolution before continuing, in which case the user may access the display screen 530C to determine what needs to be done;
intractable/workflow-stopping problem (requiring the user's immediate attention and resolution before continuing, in which case the user may access the display screen 530C to determine what needs to be done); and/or
visual inspection (e.g., indicating testing per se is not taking place, but rather the user(s) are visually inspecting the ferrule surfaces/end connectors of the fiber optic cable/DUT).

In some examples, different gradations of colors may be displayed by the integrated feedback light/button 515C to indicate different gradations of status (e.g., a pale yellow to indicate ready to attach to the fiber optic cable/DUT; a medium yellow to indicate ready to confirm another test device is at the other end of the fiber optic cable/DUT to which the test device has connected; and a strong/bright yellow to indicate the fiber optic cable/DUT is ready to be tested, i.e., the user may depress the integrated feedback light/button 515C now, after confirming a successful connection with the other test device is at the other end of the fiber optic cable/DUT

In some examples, the integrated feedback light/button 515C may utilize other modulations and/or changes in color, besides or in addition to using different colors and/or gradations of colors (or lack of any displayed color), as status/indicia. In such examples, the integrated feedback light/button 515C may appear as a progress bar, indicating, e.g., how far the series of checks, processes, measurements, tests, and/or procedures has gotten and how far there is to go, by, e.g., lighting up a linear portion of the integrated feedback light/button 515C roughly equivalent to the percentage of the series of checks, processes, measurements, tests, and/or procedures completed and not lighting the remaining linear portion of the integrated feedback light/button 515C (which would be roughly equivalent to the percentage of time remaining to complete the series of checks, processes, measurements, tests, and/or procedures). In such an example, the linear progression might be indicated by a progress bar having two different colors, or having multiple gradations of a single color, or having one color indicating progress and the remaining portion of the integrated feedback light/button 515C unlit/dark to indicate how much remains, etc., as would be understood by one of ordinary skill in the art in light of the teachings of the present disclosure.

In some examples, the integrated feedback light/button 515C may be implemented as a simple touchscreen having relatively limited display presentation capabilities besides color and manipulations of color; in other examples, the integrated feedback light/button 515C may be implemented as a touchscreen capable of displaying more complicated shapes, images, icons, and/or the like, as well as text and/or video. In accordance with the present paragraph, the light source in the integrated feedback light/button 515C may include, e.g., light emitting diodes (LEDs), a liquid crystal display (LCD), and/or other light sources suitable for usage with examples of the present disclosure, as would be understood by one of ordinary skill in the art in light of the examples of the present disclosure.

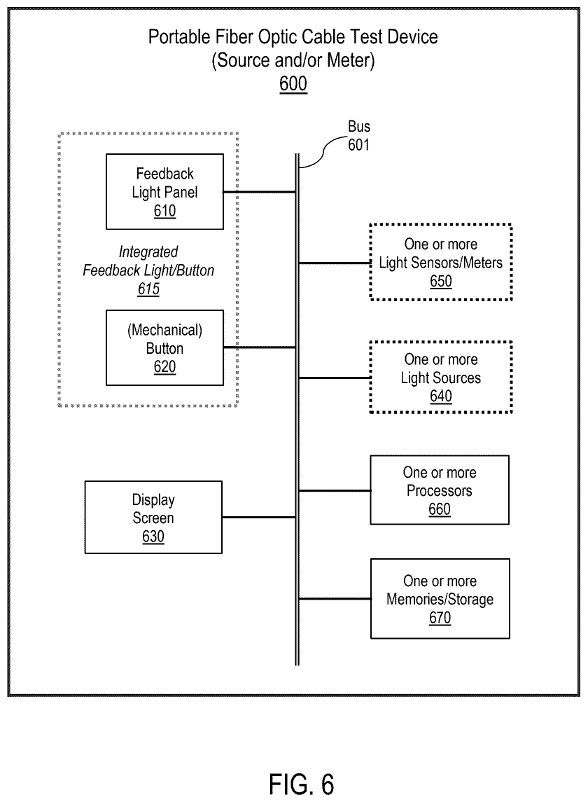

FIG. 6 is a schematic block diagram illustrating the components of a portable fiber optic cable test device 600 according to examples of the present disclosure. FIG. 6 is provided to illustrate the components of the portable fiber optic cable test device 600 according to examples of the present disclosure, and may omit aspects, features, and/or other components of the portable fiber optic cable test device 600 not germane to examples of the present disclosure, as would be understood by one of ordinary skill in the art. As FIG. 6 is a schematic block diagram, the components shown in FIG. 6 are not shown in accurate aspect and/or ratio of relative sizes, but rather shown in terms of each of their relative functions. In various examples according to the present example, any of the components shown in FIG. 6 may be implemented by several components, and several of the components shown in FIG. 6 may be combined together and implemented by a single component. In other words, the appearance of the components in FIG. 6 are not intended to correspond to the actual sizes, proportions, relative aspects, etc., of actual implementations of those components, as would be understood by one of ordinary skill in the art, but are rather intended to illustrate and aid in the explanation and description of the functioning and use of those components in the examples of the present disclosure.

FIG. 6 shows the portable fiber optic cable test device 600 has a number of components connected by a bus 601. The bus 601 may be employed for purposes of communication, control, and/or power transmission, as would be understood by one of ordinary skill in the art. In some examples, all or most of the components may be connected by a single bus; in some examples, all or most of the components may be connected by multiple means, including one-to-one connections for, e.g., purposes of control, etc., as would be understood by one of ordinary skill in the art.

The portable fiber optic cable test device 600 in FIG. 6 may include a feedback light panel 610, a button 620 (which may, or may not, be mechanical), and a display screen 630, similarly to the feedback light panel 510A/B, the (mechanical) button 520A/B, and the display screen 530A/B shown in FIGS. 5A-5B, connected to the bus 601. In some examples, the feedback light panel 610 and the (mechanical) button 620 may be implemented as an integrated feedback light/button 615, the gray dashed line box enclosing both the feedback light panel 610 and the (mechanical) button 620 and labelled “Integrated Feedback Light/Button 615” in FIG. 6 represent the examples having this implementation. In such examples, the integrated feedback light/button 615 may appear similarly to the integrated feedback light/button 515C of the portable fiber optic cable test device 500C in FIG. 5C.

In some examples, the integrated feedback light/button 615 may include a feedback light display source integrated into a mechanical push-button movable by a user; and/or a feedback light display source integrated into, and/or implemented as, a capacitive-, a resistive-, and/or any other touch-sensitive surface/technology suitable for usage with examples of the present disclosure, as would be understood by one of ordinary skill in the art in light of the examples of the present disclosure. In some examples, the integrated feedback light/button 615 may be any combination of functional elements capable of both emitting a status/indicia light display and receiving physical input registering the touch of the user, and suitable for usage with examples of the present disclosure, as would be understood by one of ordinary skill in the art in light of the examples of the present disclosure.

The portable fiber optic cable test device 600 in FIG. 6 has both one or more light sources 640 and one or more light sensors/meters 650 connected to the bus 601. The one or more light sources 640 and the one or more light sensors/meters 650 are shown in dashed line boxes in FIG. 6 to indicate that one or both of these components may be present, depending on whether the portable fiber optic cable test device 600 is a power source test device (i.e., thusly having the one or more light sources 640 for providing one or more test inputs), a meter test device (i.e., thusly having the one or more light sensors/meters 650 for testing/measuring one or more test outputs), or a combination source/meter test device capable of both providing test input and measuring test output (i.e., thusly having both the one or more light sources 640 and the one or more light sensors/meters 650). Accordingly, the portable fiber optic cable test device 600 in FIG. 6 may be a power source test device, a meter test device, or a combination source/meter test device, and may also be referred to as the “portable fiber optic cable test device (source and/or meter) 600” herein. As mentioned above, even when the portable fiber optic cable test device 600 is only a power source test device or only a meter test device, the portable fiber optic cable test device 600 may still have both one or more light sources and one or more light sensors/meters utilized for a variety of purposes.

The one or more light sources 640 may include one or more laser sources and/or one or more type of LED. The one or more light sensors/meters 650 may include one or more photodiodes and/or other sensor/meters suitable for fiber optic cable measurement/testing, as would be understood by one of ordinary skill in the art. In some examples, the one or more light sensors/meters 650 may include, for example, any type of power measurement device or power meter; any type of transmissibility measurement device or meter (such as, e.g., an Insertion Loss/Return Loss meter, a Swept Wavelength meter, an Optical Time-Domain Reflectometer (OTDR), an Optical Spectrum Analyzer (OSA), etc.); any type of network transmission analyzer (which may test for, e.g. adherence to specific protocols and/or standards); etc., as would be understood by one of ordinary skill in the art. Although not shown in FIG. 6, the portable fiber optic cable test device 600 may include any type of system for viewing and/or analyzing the output of a separate microscopic system that views the bare ends and/or end connectors of fiber optic cables.

The one or more processors 660 may communicate with and/or may be in operable control of any one or more of the feedback light panel 610, the (mechanical) button 620, the integrated feedback light/button 615 (in examples having such an implementation), the display screen 630, the one or more light sources 640, and/or the one or more light sensors/meters 650. In some examples, the portable fiber optic cable test device 600 may have a multitude of separate processors, controllers, and/or drivers involved in the control and operation of each or any of the feedback light panel 610, the (mechanical) button 620, the integrated feedback light/button 615 (in examples having such an implementation), the display screen 630, the one or more light sources 640, and/or the one or more light sensors/meters 650.

The portable fiber optic cable test device 600 may have one or more memories/storage 670 being communicatively connected with the one or more processors 660 (in FIG. 6, via the bus 601). The one or more memories/storage 670 may include any number of non-transitory computer-readable storage media which may store instructions that, when executed by the one or more processors 660, may cause the one or more processors 660 to perform any of the functions described herein and/or to control any of the components shown in one or more memories/storage 670 in FIG. 6 to perform any of the functions described herein. As used herein, “media” should be understood as the term is used in typical English parlance, i.e., as including both the singular (“medium”) and the plural (“media”).

In some examples, the one or more processors 660 may include a general purpose single-and/or multi-chip processor, a single-and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine.

In some examples, the one or more memories/storage 670 may include multiple distributed and/or separate memories. As stated above, the one or more memories/storage 670 may include a non-transitory computer-readable storage media which storing instructions that, when executed, cause one or more processors 660 to perform any of the functions described herein and/or to control any of the components to perform any of the functions described herein. In some examples, the non-transitory computer-readable storage media may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the one or more memories/storage 670 may be volatile and/or non-volatile memory, and may include database components, object code components, script components, or any other type of information structure suitable for implementing the various activities and storage functions described herein.

As mentioned above, the portable fiber optic cable test device 600 may have a number of components which are not shown in FIG. 6, such as, for example, one or more ports for connecting, via one or more test reference cords, to one or more fiber optic cables; and/or a microscope or a port for connecting to a microscope for visual inspections of end connector surfaces.

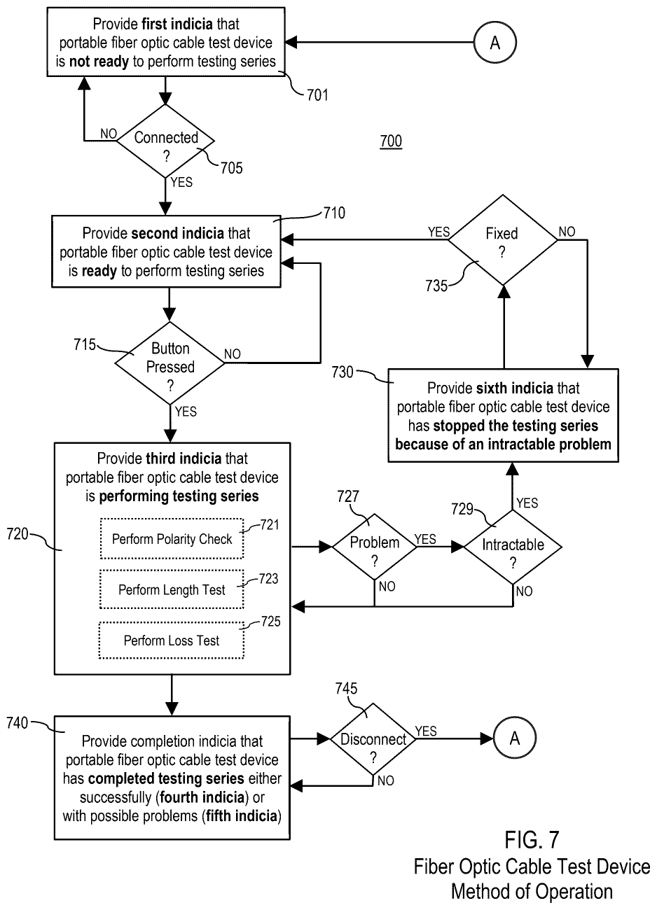

FIG. 7 is a flow diagram illustrating a method 700 for a portable fiber optic cable test device to perform tests/measurements, according to examples of the present disclosure. The method 700 is provided by way of example, as there may be a variety of ways to carry out the method(s) described herein, and may be one part of an entire process, procedure, ongoing operation, method, etc., as would be understood by one of ordinary skill in the art. The method 700 may further omit parts of any process, procedure, ongoing operation, method, etc., not germane to examples of the present disclosure, as would be understood by one of ordinary skill in the art, and each block shown in FIG. 7 may further represent one or more steps, processes, methods, or subroutines, as would be further understood by one of ordinary skill in the art. For the sake of convenience and ease of explanation, the blocks in FIG. 7 may refer to the components shown in the FIGS. described herein; however, the method 700 is not necessarily limited to any of the specific components, apparatuses, and/or constructions described and/or shown in any of the other FIGS. herein. Some of the processes indicated by the blocks in FIG. 7 may overlap, occur substantially simultaneously, and/or be continually repeated, and, moreover, the blocks may be performed by different processing components, as would be understood by one of ordinary skill in the art.

In some examples, the method 700 may be performed, in all or in part, by the one or more processors 660 in the portable fiber optic cable test device (source and/or meter) 600 in FIG. 6, controlling and/or communicating with the other components in the portable fiber optic cable test device (source and/or meter) 600 in FIG. 6, and executing instructions stored in the one or more memories/storage 670 in the portable fiber optic cable test device (source and/or meter) 600 in FIG. 6. In some examples, the method 700 may be performed, in all or in part, by any one or more of the portable fiber optic cable test devices 500A, 500B, and 500C shown in FIGS. 5A, 5B, and 5C.

As shown by the circled A in FIG. 7, the method 700 is intended to be repeated for each fiber optic cable/DUT to be tested—i.e., once the portable fiber optic cable source/meter test device has successfully performed the series of checks, processes, measurements, tests, and/or procedures and been disconnected from the fiber optic cable/DUT which was tested, the method 700 returns, via the circled A, to start again on the next fiber optic cable/DUT.

At block 701, the portable fiber optic cable source/meter test device (i.e., the test device may be a source, a meter, or both) may provide a first indicia which indicates that the portable fiber optic cable source/meter test device is not ready to perform a series of checks, processes, measurements, tests, and/or procedures (hereinafter, the series of checks, processes, measurements, tests, and/or procedures may also be referred to as the “testing series”). In some examples, the first indicia may be a specific color (e.g., yellow) shown on a feedback light panel such as, e.g., the feedback light panel 510A/B in the portable fiber optic cable test device 500A/B of FIGS. 5A-5B; the feedback light panel 610 in the portable fiber optic cable test device 600 of FIG. 6; and/or the integrated feedback light/button 515C and 615 of the portable fiber optic cable test device 500C of FIGS. 5C and 600 of FIG. 6, respectively.

In some examples, a visual inspection of the ferrule surface(s)/end connector(s) of the fiber optic cable/DUT may also be performed. In examples such as those in which Tier 1 testing is performed, a visual inspection may be part of the testing series and thus performed for each of the fiber optic cable/DUTs. In some examples, the portable fiber optic cable source/meter test device may direct the user to perform a visual inspection based on the testing/measurements of the fiber optic cable/DUT. For instance, as discussed below in reference to blocks 729-720-735, unclean ferrule surface(s)/end connector(s) may cause an intractable/workflow-stopping problem, and, in some examples, the portable fiber optic cable source/meter test device may recommend that the user either perform a visual inspection and/or clean the ferrule surface(s)/end connector(s) of the fiber optic cable/DUT.

At block 705, it is determined whether the portable fiber optic cable source/meter test device has been properly connected by the user to the fiber optic cable/DUT. Until the portable fiber optic cable source/meter test device has been properly connected, the portable fiber optic cable source/meter test device continues showing the first indicia from block 701 that the portable fiber optic cable source/meter test device is not ready to perform the testing series (as indicated in FIG. 7 by the “NO” arrow from block 705 back to block 701). Once the portable fiber optic cable source/meter test device has been properly connected, the method 700 proceeds to block 710 (as indicated in FIG. 7 by the “YES” arrow from block 705 to block 710).

As would be understood by one of ordinary skill in the art, other steps, processes, and/or procedures may be performed before and/or during blocks 701 and 705, such as, for example, providing/setting reference values for the meters/sensors and/or light sources of the portable fiber optic cable source/meter test device using the reference test cords to be used: connecting the reference test cord with the suitable adapter (if needed) and then to the end connector of the fiber optic cable/DUT; establishing that, in the applicable examples, a portable fiber optic cable source test device is attached at one end of the fiber optic cable/DUT and a matching portable fiber optic cable meter test device is attached at the other end of the fiber optic cable/DUT; and/or establishing, in the applicable examples, a communication link between the portable fiber optic cable source test device attached at one end of the fiber optic cable/DUT and the matching portable fiber optic cable meter test device attached at the other end of the fiber optic cable/DUT.

At block 710, the portable fiber optic cable source/meter test device may provide second indicia that the portable fiber optic cable source/meter test device is ready to perform the testing series. In some examples, the second indicia may be a specific color (e.g., green) shown on a feedback light panel such as, e.g., the feedback light panel 510A/B in the portable fiber optic cable test device 500A/B of FIGS. 5A-5B the feedback light panel 610 in the portable fiber optic cable test device 600 of FIG. 6; and/or the integrated feedback light/button 515C/615 of the portable fiber optic cable test device 500C/600 of FIG. 5/6.

At block 715, it is determined whether the (mechanical) button on the portable fiber optic cable source/meter test device has been pressed by the user. In some examples, the mechanical button may be, e.g., the (mechanical) button 520A/B in the portable fiber optic cable test device 500A/B of FIGS. 5A-5B; the (mechanical) button 620 in the portable fiber optic cable test device 600 of FIG. 6; and/or the integrated feedback light/button 515C/615 of the portable fiber optic cable test device 500C/600 of FIG. 5/6. Until the (mechanical) button is pressed, the portable fiber optic cable source/meter test device continues showing the second indicia from block 710 indicating that the portable fiber optic cable source/meter test device is ready to perform the testing series (as indicated in FIG. 7 by the “NO” arrow from block 715 back to block 710). Once the (mechanical) button is pressed, the method 700 proceeds to block 720 where the portable fiber optic cable source/meter test device performs the testing series (as indicated in FIG. 7 by the “YES” arrow from block 715 to block 720).

At block 720, after the user has pressed the (mechanical) button in block 715, the portable fiber optic cable source/meter test device may provide a third indicia indicating that the portable fiber optic cable source/meter test device is presently performing the series of checks, processes, measurements, tests, and/or procedures (or “testing series”). In some examples, the third indicia may be a specific color (e.g., blue) shown on a feedback light panel such as, e.g., the feedback light panel 510A/B in the portable fiber optic cable test device 500A/B of FIGS. 5A-5B; the feedback light panel 610 in the portable fiber optic cable test device 600 of FIG. 6; and/or the integrated feedback light/button 515C/615 of the portable fiber optic cable test device 500C/600 of FIG. 5/6. In some examples, as discussed above, the third indicia in block 720 may further indicate the progression of the testing series by showing a linear progress bar in the feedback light panel and/or the integrated feedback light/button, by showing two or more different colors, by showing gradations of a single color, and/or by showing varying levels of brightness.

In the example of FIG. 7, the testing series which the portable fiber optic cable source/meter test device is presently performing in block 720 may include Tier 1 testing according to the ANSI/TIA-568.3 standard, which includes link attenuation testing (or “loss” testing), link length testing, and a polarity check, although, as discussed below, examples of the present disclosure are not limited to these three Tier 1 tests, but rather may be applied to any series of checks, processes, measurements, tests, and/or procedures appropriate for a fiber optic cable. More specifically, in block 720, the portable fiber optic cable source/meter test device is presently performing the parity check on the fiber optic cable/DUT in sub-block 721, the length test in sub-block 723, and the loss test in sub-block 725. Although numbered sequentially, the parity check in sub-block 721, the length test in sub-block 723, and the loss test in sub-block 725 may be performed in any order, and/or partially in parallel.

As mentioned above, the series of checks, processes, measurements, tests, and/or procedures performed in block 720 may include other tests besides, and/or in addition to, the three tier 1 tests shown in block 720—the particular checks, processes, measurements, tests, and/or procedures performed in block 720 may vary widely and may be tailored to the specific fiber optic cable/DUT, the particular end connector, the communication usage of the fiber optic cable/DUT, the particular environment in which the fiber optic cable/DUT may be used, etc., as would be understood by one of ordinary skill in the art. In some examples, the test or tests performed by the test device may be established by various industry associations, such as the Fiber Optic Association (FOA); the Building Industry Consulting Service International (BICSI); ANSI; EIA/TIA; IEC and/or IOS; the 3^{rd} Generation Partnership Project (3GPP), which promulgates evolving telecommunications standards such as Long Term Evolution (LTE), 5G, 5GNR, and 6G; the European Telecommunications Institute (ETSI); the Open Radio Access Network (O-RAN) Alliance; the Institute of Electrical and Electronic Engineers (IEEE); and the International Telecommunications Union (ITU); and the American National Standards Institute (ANSI). As specific, non-limiting examples (in addition to any others mentioned herein), the IEC has promulgated IEC 61300-3-35, which specifies pass/fail requirements for fiber optic cable overall quality, ferrule end-faces, end connectors, life cycle objectives, etc. ; the IEEE has promulgated IEEE 802.3z, 802.3ae, 802.3db, etc., as various optical Ethernet standards; the FOA has promulgated FOA-3 for measuring optical power, FOA-4 for OTDR testing, etc. ; and ANSI and TIA have promulgated ANSI/TIA-455-95-B for Absolute Optical Power Test for Optical Fibers and Cables.

In some examples, during the testing series, while the portable fiber optic cable source/meter test device is providing the third indicia indicating that it is presently performing the testing series in block 720, a display screen disposed on the portable fiber optic cable source/meter test device may show information/details regarding the on-going testing series being performed.

At block 727, it is determined whether a problem has occurred during the on-going testing series in block 720. Although block 727 is shown separately from block 720 in FIG. 7, it should be understood that the checking for a problem shown in block 727 is continuously being performed during the testing series in block 720. Accordingly, until the testing series in block 720 has completed, the portable fiber optic cable source/meter test device continues showing the third indicia indicating that the portable fiber optic cable source/meter test device is performing the testing series from block 720 if no problems are detected (as indicated in FIG. 7 by the “NO” arrow from block 727 back to block 720). If a problem is detected in block 727, the method 700 proceeds to block 729 (as indicated in FIG. 7 by the “YES” arrow from block 727 to block 729).

In some examples, when a problem is detected in block 727 during the testing series, a display screen disposed on the portable fiber optic cable source/meter test device may show information/details regarding the detected problem.

At block 729, it is determined whether the problem detected in block 727 is intractable. In this context, an “intractable” problem (or “workflow-stopping problem”) is a problem that will prevent the portable fiber optic cable source/meter test device from completing the testing series in block 720. If it is determined the problem is not intractable (and thus the testing series in block 720 may continue), the portable fiber optic cable source/meter test device continues the testing series in block 720 and continues showing the third indicia indicating that the portable fiber optic cable source/meter test device is performing the testing series (as indicated in FIG. 7 by the “NO” arrow from block 729 back to block 720). If the detected problem is determined to be intractable in block 729, the method 700 proceeds to block 730 (as indicated in FIG. 7 by the “YES” arrow from block 729 to block 730).

At block 730, having determined an intractable problem has occurred in block 729, the portable fiber optic cable source/meter test device may provide a sixth indicia indicating that the portable fiber optic cable source/meter test device has stopped performing the testing series because of an intractable problem. In some examples, the sixth indicia may be a specific color (such as, e.g. red) shown on a feedback light panel such as, e.g., the feedback light panel 510A/B in the portable fiber optic cable test device 500A/B of FIGS. 5A-5B; the feedback light panel 610 in the portable fiber optic cable test device 600 of FIG. 6; and/or the integrated feedback light/button 515C/615 of the portable fiber optic cable test device 500C/600 of FIG. 5/6.

After finding an intractable problem and providing the sixth indicia indicating that the portable fiber optic cable source/meter test device has stopped performing the testing series because of the intractable problem in block 730, the user may attempt to fix the intractable problem in order to restart the testing series. In some examples, the portable fiber optic cable source/meter test device may identify the cause of the intractable problem on the display screen so the user may attempt to fix it. In some examples, the portable fiber optic cable source/meter test device may provide, via the display screen, recommendations and/or guidance to the user regarding fixing the intractable problem.

At block 735, it is determined whether the intractable problem has been fixed by the user. If it is determined the intractable problem has not been fixed, the portable fiber optic cable source/meter test device continues showing the sixth indicia (e.g., the color red on the feedback light panel and/or the integrated feedback light/button) indicating that the portable fiber optic cable source/meter test device has stopped the testing series because of an intractable problem (as indicated in FIG. 7 by the “NO” arrow from block 735 back to block 730). If it is determined the intractable problem has been fixed, the portable fiber optic cable source/meter test device may switch back to showing the second indicia (e.g., the color green on the feedback light panel and/or the integrated feedback light/button) indicating that the portable fiber optic cable source/meter test device is again ready to perform the testing series (as indicated in FIG. 7 by the “YES” arrow from block 735 back to block 710). In other examples, the method 700 may return to the point in the testing series where the intractable problem occurred, and then continue the testing series from that point.

For instance, an intractable/workflow-stopping problem may be an indication that the ferrule surface(s)/end connector(s) of the fiber optic cable/DUT are so unclean that it may be affecting the accuracy of the testing/measurements of the fiber optic cable/DUT. In such a case, the portable fiber optic cable source/meter test device may direct the user to either perform a visual inspection and/or clean the ferrule surface(s)/end connector(s) of the fiber optic cable/DUT. When and if the portable fiber optic cable source/meter test device determines the ferrule surface(s)/end connector(s) are sufficiently clean in block 735, the method 700 may start the testing series over (as indicated in FIG. 7 by the “YES” arrow from block 735 back to block 710) or, in other examples, the method 700 may return to the point in the testing series (block 720) where unclean ferrule surface(s)/end connector(s) were indicated, and then continue the testing series from that point (in block 720).

If there have been no intractable/workflow-stopping problems (or any intractable/workflow-stopping problems were fixed), the testing series completes and, at block 740, the portable fiber optic cable source/meter test device may provide a completion indicia indicating that the portable fiber optic cable source/meter test device has completed the testing series. In some examples, the completion indicia may be a specific color (e.g., purple) shown on a feedback light panel such as, e.g., the feedback light panel 510A/B in the portable fiber optic cable test device 500A/B of FIGS. 5A-5B; the feedback light panel 610 in the portable fiber optic cable test device 600 of FIG. 6; and/or the integrated feedback light/button 515C/615 of the portable fiber optic cable test device 500C/600 of FIG. 5/6.

In some examples, the completion indicia shown in block 740 may be one of two different indicia: a fourth indicia indicating there were no problems of any sort during the testing series, or a fifth indicia indicating there were one or more non-intractable problems detected at block 727 during the testing series, which may indicate there are possible problems with the testing results, the fiber optic cable/DUT and/or the portable fiber optic cable source/meter test device, and thus the user should review certain tests, parameters, and/or other matters before proceeding with testing the next fiber optic cable/DUT. In some examples, the portable fiber optic cable source/meter test device may provide, via the display screen, recommendations and/or guidance to the user regarding resolving the one or more possible problems with the testing results, the fiber optic cable/DUT and/or the portable fiber optic cable source/meter test device.

At block 745, it is determined whether the portable fiber optic cable source/meter test device has been disconnected from the fiber optic cable/DUT for which the testing series completed in block 740. Accordingly, after the testing series in block 720 has completed, the portable fiber optic cable source/meter test device continues showing the completion indicia from block 740 indicating that the portable fiber optic cable source/meter test device has completed the testing series while the fiber optic cable/DUT remains connected (as indicated in FIG. 7 by the “NO” arrow from block 745 back to block 740). Once the fiber optic cable/DUT is disconnected, the method 700 returns back to block 701 (as indicated in FIG. 7 by the “YES” arrow from block 745 to the circled A, which also appears at the top of FIG. 7 pointing an arrow at block 701, as discussed above). In o ther words, by the method 700 returning to block 701, the portable fiber optic cable source/meter test device is indicating it is waiting to connect to the next fiber optic cable/DUT.

Because intractable/workflow-stopping problems like those referenced in blocks 729-730-735 are relatively infrequent, the user of the portable fiber optic cable source/meter test device operating according to the method 700 in FIG. 7 will proceed through testing the majority of fiber optic cables/DUTs by simply connecting each one and pressing a single button without interruption. Accordingly, the interactions required from users of the present portable fiber optic cable source/meter test device may be greatly reduced, thereby leading to a greatly streamlined/optimized workflow, and overall efficiency gains. In some examples, other activities may be included, such as, e.g., visual inspection of the ferrule surfaces/end connectors of the fiber optic cables/DUTs (in, e.g., Tier 1 testing), but even with such extra activity, the workflow is still greatly streamlined/optimized by the present portable fiber optic cable test source/meter device.

In some examples, all of the details and parameters of the testing series and the testing results are separately stored and identified as corresponding to a unique fiber optic cable/DUT. For instance, in such examples, a user and/or a supervisor may retrieve and review the link loss values and margins for each fiber in a specific 12-fiber MPO connector fiber optic cable in a specific cassette in a specific room on a certain floor of a data center, like those shown in FIG. 4.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

Generally speaking, any one or more of the components and/or functionalities described herein may be implemented by hardware, software, and/or any combination thereof, according to examples of the present disclosure. In some examples, the components and/or functionalities may be implemented by any type of application, program, library, script, task, service, process, and/or any type or form of executable instructions executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the hardware and data processing components used to implement the various processes, operations, logic, and circuitry described in connection with the examples described herein may be implemented with a general purpose single-and/or multi-chip processor, a single-and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory/storage may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the memory/storage may be volatile and/or non-volatile memory, and may include database components, object code components, script components, or any other type of information structure suitable for implementing the various activities and storage functions described herein.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

In summary and conclusion, what has been described and illustrated herein are examples along with variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated (by, for example, being defined herein).

1. A portable fiber optic cable test device, comprising:
a port to connect to a fiber optic cable as a device under test (the fiber optic cable/DUT);
an integrated feedback light/button to be physically pressed by a user and to display a plurality of indicia indicating a status of testing the fiber optic cable/DUT; and
a processor operatively connected to the port and the integrated feedback light/button, and communicatively connected to a non-transitory computer-readable memory storing instructions executable by the processor, wherein, when executing the stored instructions, the processor:
controls the integrated feedback light/button to display a first indicia indicating the portable fiber optic cable test device is not ready to perform testing when the fiber optic cable/DUT is not properly connected to the port;
controls the integrated feedback light/button to display a second indicia indicating the portable fiber optic cable test device is ready to perform testing when the fiber optic cable/DUT is properly connected to the port;
controls, when the integrated feedback light/button is detected being depressed while the second indicia is being displayed, the portable fiber optic cable test device to automatically perform testing on the connected fiber optic cable/DUT; and
controls the integrated feedback light/button to display a third indicia indicating the portable fiber optic cable test device is performing testing while the testing is being automatically performed on the fiber optic cable/DUT.

2. The portable fiber optic cable test device of claim 1, wherein the testing comprises Tier 1 testing, including at least one of a loss test, a length test, or a polarity check.

3. The portable fiber optic cable test device of claim 1, wherein the integrated feedback light/button comprises a button and a feedback light source integrated together,
wherein the button comprising at least one of a mechanical push-button which is physically moved by pressure from a user, a capacitive surface which may be capacitively coupled with a digit of a user, a resistive surface which detects pressure applied thereto, or any other touch-sensitive surface, and
wherein the feedback light source comprises at least one of a liquid crystal display (LCD) or a light emitting diode (LED).

4. The portable fiber optic cable test device of claim 1, wherein each of the plurality of indicia displayed by the integrated light feedback/button is a different color.

5. The portable fiber optic cable test device of claim 1, wherein the third indicia displayed by the integrated light feedback/button further indicates a progression of the testing being automatically performed on the fiber optic cable/DUT.

6. The portable fiber optic cable test device of claim 1, wherein, when executing the stored instructions, the processor further:
controls the integrated light feedback/button to display a fourth indicia indicating the portable fiber optic cable test device has completed testing when the testing of the fiber optic cable/DUT has been completed.

7. A portable fiber optic cable test device, comprising:
a port to connect to a fiber optic cable as a device under test (the fiber optic cable/DUT);
a feedback light panel to display a plurality of indicia indicating a status of testing the fiber optic cable/DUT;
a button to be physically pressed by a user; and
a processor operatively connected to the feedback light panel, the button, and the port, and communicatively connected to a non-transitory computer-readable memory storing instructions executable by the processor, wherein, when executing the stored instructions, the processor:
controls the feedback light panel to display a first indicia indicating the portable fiber optic cable test device is not ready to perform testing when the fiber optic cable/DUT is not properly connected to the port;
controls the feedback light panel to display a second indicia indicating the portable fiber optic cable test device is ready to perform testing when the fiber optic cable/DUT is properly connected to the port;
controls, when the button is detected being depressed while the second indicia is being displayed, the portable fiber optic cable test device to automatically perform Tier 1 testing on the connected fiber optic cable/DUT, wherein the Tier 1 testing comprises a polarity check, a link test, and a length test of the fiber optic cable/DUT; and
controls the feedback light panel to display a third indicia indicating the portable fiber optic cable test device is performing testing while the Tier 1 testing is being automatically performed on the fiber optic cable/DUT.

8. The portable fiber optic cable test device of claim 7, wherein the button comprises at least one of a mechanical push-button which is physically moved by pressure from a user, a capacitive surface which may be capacitively coupled with a digit of a user, a resistive surface which detects pressure applied thereto, or any other touch-sensitive surface.

9. The portable fiber optic cable test device of claim 7, wherein each of the plurality of indicia is a different color.

10. The portable fiber optic cable test device of claim 7, wherein the third indicia further indicates a progression of the Tier 1 testing being automatically performed on the fiber optic cable/DUT by displaying a linear progress bar on the feedback light panel.

11. The portable fiber optic cable test device of claim 7, wherein, when executing the stored instructions, the processor further:
controls the feedback light panel to display a fourth indicia indicating the portable fiber optic cable test device has completed testing when the Tier 1 testing of the fiber optic cable/DUT has been completed.

12. The portable fiber optic cable test device of claim 11, further comprising:
a display screen to display information regarding testing the fiber optic cable/DUT, wherein the processor is operatively connected to the display screen.

13. The portable fiber optic cable test device of claim 12, wherein, when executing the stored instructions, the processor further:
controls the feedback light panel to display a fifth indicia indicating the portable fiber optic cable test device has completed Tier 1 testing but also indicating that the user is to review the display screen; and
controls the display screen to display recommendations for one or more actions for the user to perform to confirm the accuracy of the Tier 1 testing, when the Tier 1 testing of the fiber optic cable/DUT has been completed but potential problems are indicated with some or all of the Tier 1 testing.

14. The portable fiber optic cable test device of claim 13, wherein, when executing the stored instructions, the processor further:
controls the feedback light panel to display a sixth indicia indicating the portable fiber optic cable test device has stopped testing before completion when an intractable problem arises with the Tier 1 testing of the fiber optic cable/DUT; and
controls the display screen to display recommendations for one or more actions for the user to perform to correct the intractable problem.

15. A method for a portable fiber optic cable test device to test a fiber optic cable as a device under test (the fiber optic cable/DUT), comprising:
controlling, by a processor operatively connected to a feedback light panel, the feedback light panel to display a first indicia indicating the portable fiber optic cable test device is not ready to perform testing when the fiber optic cable/DUT is not properly connected to a port of the portable fiber optic cable test device;
controlling, by the processor, the feedback light panel to display a second indicia indicating the portable fiber optic cable test device is ready to perform testing when the fiber optic cable/DUT is properly connected to the port;
detecting, by the processor operatively connected to a button, if the button is depressed while the second indicia is being displayed;
controlling, by the processor when the button is detected being depressed while the second indicia is being displayed, the portable fiber optic cable test device to automatically perform Tier 1 testing on the connected fiber optic cable/DUT, wherein the Tier 1 testing comprises:
a polarity check of the fiber optic cable/DUT;
a link test of the fiber optic cable/DUT; and
a length test of the fiber optic cable/DUT; and
controlling, by the processor, the feedback light panel to display a third indicia indicating the portable fiber optic cable test device is performing testing while the Tier 1 testing is being automatically performed on the fiber optic cable/DUT.

16. The method of claim 15, wherein each of the plurality of indicia is a different color.

17. The method of claim 15, further comprising:
controlling, by the processor, the feedback light panel to display a fourth indicia indicating the portable fiber optic cable test device has completed testing when the Tier 1 testing of the fiber optic cable/DUT has been completed.

18. The method of claim 17, further comprising:
controlling, by the processor, the feedback light panel to display a fifth indicia indicating the portable fiber optic cable test device has completed Tier 1 testing but also indicating that the user is to review a display screen disposed on the portable fiber optic cable test device; and
controlling, by the processor, the display screen to display recommendations for one or more actions for the user to perform to confirm the accuracy of the Tier 1 testing, when the Tier 1 testing of the fiber optic cable/DUT has been completed but potential problems are indicated with some or all of the Tier 1 testing.

19. The method of claim 18, further comprising:
controlling, by the processor, the feedback light panel to display a sixth indicia indicating the portable fiber optic cable test device has stopped testing before completion when an intractable problem arises in the Tier 1 testing of the fiber optic cable/DUT; and
controlling, by the processor, the display screen to display recommendations for one or more actions for the user to perform to correct the intractable problem.

20. The method of claim 17, further comprising:
detecting, by the processor, if the fiber optic cable/DUT is disconnected from the portable fiber optic cable test device while the fourth indicia indicating the portable fiber optic cable test device has completed testing of the fiber optic cable/DUT is being displayed; and
controlling, by the processor when the fiber optic cable/DUT is detected being disconnected from the portable fiber optic cable test device, the feedback light panel to display the first indicia indicating the portable fiber optic cable test device is not ready to perform testing until a next fiber optic cable/DUT is properly connected to the portable fiber optic cable test device.
